(19) United States
(12) Patent Application Publication
(10) Pub. No.: US 2019/0203015 A1
(43) Pub. Date: Jul. 4, 2019

(54) PLASTIC PRODUCTS EXHIBITING SUPERIOR IMPACT RESISTANCE AND METHODS FOR INJECTION MOLDING THE SAME

(71) Applicant: Stephen B. Maguire, West Chester, PA (US)

(72) Inventor: Stephen B. Maguire, West Chester, PA (US)

(21) Appl. No.: 16/296,579

(22) Filed: Mar. 8, 2019

Related U.S. Application Data
(63) Continuation-in-part of application No. 14/472,490, filed on Aug. 29, 2014.
Application No. 14/472,490 is a continuation-in-part of application No. 15/432,495, filed on Feb. 14, 2017.
Application No. 15/432,495 is a continuation of application No. 14/333,579, filed on Jul. 17, 2014, now Pat. No. 9,708,462.
Application No. 14/333,579 is a continuation-in-part of application No. 15/883,501, filed on Jan. 30, 2018.
Application No. 15/883,501 is a continuation-in-part of application No. 15/886,137, filed on Feb. 1, 2018.
Application No. 15/886,137 is a continuation-in-part of application No. 16/258,870, filed on Jan. 28, 2019.
(60) Provisional application No. 62/640,119, filed on Mar. 8, 2018.

(51) Int. Cl. C08K 5/09; C08J 3/205; B29C 48/29; B29C 45/00; C08K 3/013; B29C 48/06; C08J 3/22; C08K 5/00; B29C 48/94

(52) U.S. Cl. CPC C08K 5/09; C08J 3/2053; B29C 48/29; B29C 45/0001; C08K 3/013; B29K 2105/0044; B29C 48/06; C08J 3/226; C08K 5/0041; B29C 48/94; B29C 45/0013

(57) ABSTRACT

A method for increasing the impact resistance of plastic articles comprising providing a blend of cottonseed oil and plastic resin; fabricating a plastic article from the blend by rotatably screw working the blend into a molten state and molding the molten blend material into the article shape.

### CROSS REFERENCE TO RELATED PATENT PROPERTIES

This patent application claims the benefit of the priority of U.S. provisional patent application Ser. No. 62/640,119 filed 8 Mar. 2018 in the name of Stephen B. Maguire and entitled “Injection Molding Method for Improved Product Impact Resistance and Product Embodying Same. The priority of the '119 application is claimed under 35 USC 120.

This patent application is a 35 USC 120 continuation-in-part of co-pending U.S. patent application Ser. No. 14/472,490, filed 29 Aug. 2014 in the name of Stephen B. Maguire, entitled “Liquid Color Management Using Liquid Color Container Having Read-Write Memory,” published 5 Mar. 2016 as US 2015/0066794 A1. The benefit of the priority of the '490 application is claimed under 35 USC 120.

This patent application is also a 35 USC 120 continuation-in-part of co-pending U.S. patent application Ser. No. 15/432,495, filed 14 Feb. 2017 in the name of Stephen B. Maguire, entitled “Cottonseed Oil Based Liquid Color Composition and Plastics Coloring Method Using the Same”, published 1 Jun. 2017 as US 2017/0152366 A1. The benefit of the priority of the '495 application is claimed under 35 USC 120.

This patent application is also a 35 USC 120 continuation-in-part of co-pending U.S. patent application Ser. No. 15/883,501, filed 30 Jan. 2018 in the name of Stephen B. Maguire, entitled “Cottonseed Oil Based Liquid Color Composition And Plastics Coloring Method Using The Same,” published as US 2018/0155522 A1. The benefit of the priority of the '501 application is claimed under 35 USC 120.

This patent application is also a 35 USC 120 continuation-in-part of co-pending U.S. patent application Ser. No. 15/886,137, filed 1 Feb. 2018 in the name of Stephen B. Maguire, entitled Cottonseed Oil Based Additive Compositions for Plastics Molding and Extrusion published 7 Jun. 2018 as US 2018/0155523 A1. The benefit of the priority of the '137 application is claimed under 35 USC 120.

This patent application is also a 35 USC 120 continuation-in-part of co-pending U.S. patent application Ser. No. 16/258,870, filed 28 Jan. 2019 in the name of Stephen B. Maguire, entitled Liquid Color Management Methods. The benefit of the priority of the '870 application is claimed under 35 USC 120.

This patent application is also a 35 USC 120 continuation-in-part of U.S. patent application Ser. No. 14/333,579, filed 17 Jul. 2014 in the name of Stephen B. Maguire, entitled Liquid Color Composition with Cottonseed Oil Base, published 22 Jan. 2015 as US 2015/0020713 A1, issued 18 Jul. 2017 as U.S. Pat. No. 9,708,462. The benefit of the priority of the '579 application is claimed under 35 USC 120 through the '495 and '490 applications.

### STATEMENT REGARDING FEDERALLY SPONSORED RESEARCH OR DEVELOPMENT

Not applicable—this invention was conceived and developed entirely using private source funding; this patent application is being filed and paid for entirely by private source funding.

### INCORPORATION BY REFERENCE

Applicant hereby incorporates by reference the following United States patent publications: US 2015/0066794 A1; US 2017/0152366 A1; US 2018/0155522 A1; US 2018/0155523 A1; and U.S. Pat. No. 9,708,462.

### THE INVENTION

Applicant has surprisingly and unexpectedly discovered that the addition of cottonseed oil, to plastic resin in the course of injection molding of finished and semi-finished plastic articles, results in substantially improved impact resistance of the resulting molded plastic articles.

The invention provides a method for increasing the impact resistance of plastic articles where the invention includes providing a blend of cottonseed oil and plastic resin, fabricating the plastic article from the resin-cottonseed oil mixture by rotatably screw working the resin-cottonseed oil blend into a molten state, and thereafter molding the molten material into the article of interest. Most preferably, the cottonseed oil added in the course of the injection molding method is in the liquid phase.

The cottonseed oil most preferably serves as a carrier for an additive, specifically a colorant, which is added to the plastic resin in the course of the injection molding process.

Other additives may also be carried by the cottonseed oil.

The cottonseed oil may be used in a pure state, without the addition of any additives and added to the granular resin prior to or in the course of the screw working of the granular resin-cottonseed oil mixture into a molten phase, which is placed into a mold until the molten phase material has cooled sufficiently to solidify and the resulting product can be removed.

In another aspect of the invention, there is a provided a method for injection molding thermoplastic resin into finished or semi-finished plastic articles, which involves rotatably screw working resin into a molten state and thereafter placing the molten resin into a mold until the molten resin material is cooled sufficiently to solidify, where the improvement provided by the invention is the addition of cottonseed oil to the resin prior to the resin reaching the molten state.

In yet another variation, the cottonseed oil can be added while the resin is in the molten state and mixed with the molten state resin in order to achieve the desired higher impact resistance in the product resulting from molding of the resin and cottonseed oil mixture.

It is further within the scope of the invention to add the cottonseed oil to the resin before the screw working step of the injection molding process.

It is further within the scope of the invention to add the cottonseed oil to the resin during the screw working process prior to the resin reaching the molten state.

In another one of its aspects, this invention provides a plastic article having high impact resistance where the article is made by a process comprising (i) introducing resin into the screw barrel of an injection molding machine, (ii) introducing cottonseed oil into the screw barrel, (iii) screw working the resin-cottonseed oil mixture until the mixture attains a molten state, (iv) injecting the molten mixture into a mold, and (v) once the molten mixture has solidified in the mold, removing the solidified molten mixture from the mold as a plastic article.

This description is merely exemplary in nature and is not intended to limit the described embodiments of the invention or uses of the described embodiments. As used herein, the words “exemplary” and “illustrative” mean “serving as an example, instance, or for illustration.” Any implementation or embodiment or abstract disclosed herein as being “exemplary” or “illustrative” is not necessarily to be construed as preferred or advantageous over other implementations, aspects, or embodiments. All of the implementations or embodiments described are exemplary implementations and embodiments provided to enable persons of skill in the art to make and to use the implementations and embodiments as disclosed below, to otherwise practice the invention, and are not intended to limit the scope of the invention, which is defined by the claims.

Furthermore, by this disclosure, there is no intention on the part of the Applicant to be bound by any express or implied theory presented in the preceding materials, including but not limited to the summary of the invention or the description of the prior art, or in the following description of the invention. It is to be understood that the specific implementations, devices, processes, aspects, and the like described in the following portion of the application, sometimes referred to as the “specification,” are simply exemplary embodiments of the inventive concepts defined in the claims. Accordingly, specific formulation, data, and other physical characteristics relating to the embodiments disclosed herein are not to be considered as limiting as respecting the invention unless the claims or the specification expressly state otherwise.

Although schematic implementations of present invention and at least some of its advantages are described, it should be understood that various changes, substitutions and alterations may be made to the apparatus and methods disclosed herein without departing from the spirit and scope of the invention as defined by the appended claims. The disclosed embodiments are therefore to be considered in all respects as being illustrative and not restrictive with the scope of the invention being indicated by the appended claims rather than by the foregoing description. All changes which come within the meaning and range of equivalency of the claims are therefore intended to be embraced therein. Moreover, the scope of this patent application is not intended to be limited to the particular implementations of apparatus and methods described in the specification, nor to any methods that may be described or inferentially understood by those skilled in the art to be present as described in this specification.

As disclosed and from the foregoing description of exemplary embodiments of the invention, it will be readily apparent to those skilled in the art to which the invention pertains that the principles and particularly the compositions and methods disclosed herein can be used for applications other than those specifically mentioned. Further, as one of skill in the art will readily appreciate from the disclosure of the invention as set forth hereinabove that apparatus, methods, and steps presently existing or later developed, which perform substantially the same function or achieve substantially the same result as the corresponding embodiments described and disclosed hereinabove, may be utilized according to the description of the invention and the claims appended hereto. Accordingly, the appended claims are intended to include within their scope such apparatus, methods, and processes that provide the same result or which are, as a matter of law, embraced by the doctrine of the equivalents respecting the claims of this application.

As respecting the claims appended hereto, the term “comprising” means “including but not limited to”, whereas the term “consisting of” means “having only and no more”, and the term “consisting essentially o” f means “having only and no more except for minor additions which would be known to one of skill in the art as possibly needed for operation of the invention.” The scope of the invention is, therefore, indicated by the appended claims rather than by the foregoing description and all changes which come within the range of equivalency of the claims are to be considered to be embraced within the scope of the claims. Additional objects, other advantages, and further novel features of the invention will become apparent from study of the appended claims as well as from study of the foregoing detailed discussion and description of the preferred embodiments of the invention, as that study proceeds.

The following is claimed:

1. A method for increasing the impact resistance of plastic articles comprising:
a) providing a blend of cottonseed oil and plastic resin;
b) fabricating a plastic article from the blend by rotatably screw working the blend into a molten state and molding the molten blend material into the article shape.

2. The method of claim 1 wherein the cottonseed oil is in the liquid phase.

3. The method of claim 1 further comprising including an additive in the cottonseed oil-resin blend.

4. The method of claim 3 wherein the additive includes a colorant.

5. In a method for injection molding thermoplastic resin into finished or semi-finished plastic articles by rotatably screw working the resin into a molten state and thereafter placing the molten resin material into a mold until the molten resin material has cooled sufficiently to solidify, the improvement comprising adding cottonseed oil to the resin prior to the resin reaching the molten state.

6. The method of claim 5 wherein the improvement further comprises adding the cottonseed oil to the resin before screw working.

7. The method of claim 5 wherein the improvement further comprises adding the cottonseed oil to the resin during screw working prior to the resin attaining the molten state.

8. A plastic article having high impact resistance made by a process comprising:
a) introducing resin into the screw barrel of an injection molding machine;
b) introducing cottonseed oil into the screw barrel;
c) screw working the resin-cottonseed oil mixture until the mixture attains a molten state;
d) injecting the molten mixture into a mold;
e) once the molten mixture has solidified in the mold, removing the solidified molten mixture as a plastic article from the mold.
